(19) United States
(12) Patent Application Publication
(10) Pub. No.: US 2024/0269916 A1
(43) Pub. Date: Aug. 15, 2024

(54) FIBROUS PREFORM FOR MANUFACTURING AN ANNULAR CASING MADE OF COMPOSITE MATERIAL FOR A TURBINE ENGINE

(71) Applicant: SAFRAN AIRCRAFT ENGINES, Paris (FR)

(72) Inventors: Laurent Jean Baptiste BAROUMES, MOISSY-CRAMAYEL (FR); Didier FROMONTEIL, MOISSY-CRAMAYEL (FR); Hervé GRELIN, MOISSY-CRAMAYEL (FR)

(73) Assignee: SAFRAN AIRCRAFT ENGINES, Paris (FR)

(21) Appl. No.: 18/567,885

(22) PCT Filed: Jun. 3, 2022
(86) PCT No.: PCT/FR2022/051057

§ 371 Date: Dec. 7, 2023

(30) Foreign Application Priority Data
Jun. 8, 2021 (FR) FR2106023

(51) Int. Cl. B29C 53/00; B29C 53/56; B29C 53/80; B29K 101/12; B29K 105/08; B29K 105/16; B29K 507/04; B29L 31/00

(52) U.S. Cl. CPC B29C 53/005; B29C 53/56; B29C 53/8066; B29K 2101/12; B29K 2105/0854; B29K 2105/167; B29K 2507/04; B29L 2031/7504

(57) ABSTRACT

A fibrous preform for manufacturing an annular housing made of composite material for a turbine engine includes at least one layer that has a fibrous texture, has a three-dimensional or multilayer weave, and extends about a longitudinal axis. At least one mat includes a thermoplastic material filled with carbon nanotubes and extending about the axis. At least one multiaxial fibrous sheet extends about the axis. The at least one mat is inserted between the fibrous sheet and the at least one layer having a fibrous texture.

### TECHNICAL FIELD OF THE INVENTION

This invention relates to the general field of manufacturing reinforced composite revolution parts with improved impact resistance characteristics, such as structural casings for a turbine engine, in particular for an aircraft.

### TECHNICAL BACKGROUND

The prior art comprises, in particular, the documents EP-A1-3 078 466 and US-A1-2019/153876.

The use of composite materials is particularly advantageous in the field of the turbine engines, as they allow a reduction in the weight of the components combined with good mechanical properties.

A commonly used composite material comprises a fibrous preform densified with a polymer resin. The preform may be the result of a three-dimensional (3D) weaving or may be obtained by draping and superimposing several layers/plies (multilayer). The resin can be injected into the preform or the preform can be pre-impregnated with the resin (also referred to as as “prepreg”).

In the aerospace industry, the aim is to reduce the weight of the engine components while maintaining their mechanical properties at a high level. For example, a fan casing and an intermediate casing in a turbine engine are made of composite material. The fan casing defines the contour of the air intake duct of the engine and houses the rotor supporting the fan vanes. This fan casing is extended downstream by the intermediate casing. The intermediate casing surrounds the engine of the turbine engine. OGV vanes (for Outlet Guide Vane defines stator vanes) attached to the intermediate casing provide the connection between the external casings and the engine of the turbine engine.

The manufacture of the fan casing or of the intermediate casing in composite material begins by winding a fibrous preform onto a mandrel whose profile matches that of the casing to be produced. The manufacturing process continues by densifying the fibrous preform with a polymer matrix, which involves impregnating the preform with a resin and polymerising the latter to produce the final part. The casings obtained by this method have good damage resistance properties thanks to the three-dimensional weaving of the fibrous texture making up the fibrous preform of the part.

However, in the case of a fibrous preform obtained by winding a 3D woven or multi-layer strip, the fibrous preform may present a weakness at the interface between the adjacent winding turns because there is no bond in the radial direction Z in this area. In fact, at the interfaces between each layer of the preform, the cohesion of the material is ensured by the resin alone, without any reinforcement or transverse cohesion structure. As a result, this interface between the winding turns may be subject to delamination-type damage, particularly in the event of shocks or impact from a foreign body.

A delamination is, by definition, a breakdown of the composite material between the different layers making up the fibrous preform.

A delamination of the wound fibrous preform can be induced in particular during the manufacturing method for manufacturing the part (for example, by a lack of adhesion between the layers of the preform during operations of consolidation or machining the part) or when the part is subjected to stresses during operation (for example, impact stresses, stresses linked to the geometry of the part, etc.). In addition, stacking the fibrous reinforcements in different orientations between the different layers of the preform may adversely affect delamination resistance.

Furthermore, if the mechanical properties of such a casing are to be improved, it is generally necessary to increase the thickness of the layers of the fibrous texture obtained by three-dimensional weaving or multi-layer and therefore the mass of the casing.

There is therefore a need to improve the mechanical strength and the resistance to delamination of the composite casings for a turbine engine, while maintain a reduced weight.

### SUMMARY OF THE INVENTION

The present invention provides a simple, effective and economical solution to the aforementioned disadvantages of the prior art.

To this end, the invention proposes a fibrous preform for manufacturing an annular casing of composite material for a turbine engine, in particular for an aircraft, the preform comprising:
at least one layer of a fibrous texture having a three-dimensional weaving or multilayer, and extending around a longitudinal axis A;
at least one mat comprising a thermoplastic material filled with carbon nanotubes and extending around the axis A; and
at least one multiaxial fibrous sheet extending around the axis A.

According to the invention, the mat is interposed between the fibrous sheet and said at least one layer of fibrous texture.

The preform according to the invention generally allows to increase the mechanical strength of the composite material casing. The casing, incorporating such a fibrous preform as a fibrous reinforcement, allows to withstand especially stresses in directions other than those in which the yarns or strands making up the textile layers extend.

In addition, by choosing a suitable multiaxial sheet, the mechanical properties of the casing in predefined stress directions are enhanced, particularly in the orientation directions of the unidirectional fibres of the multiaxial fibrous sheet. In this way, the fibrous preform according to the invention allows to retain the advantages in terms of mechanical strength of the textile layers obtained by 3D weaving, while reinforcing them in selected directions, without significantly increasing the mass of the assembly. A multiaxial fibrous sheet can be lighter than a layer of textile obtained by 3D weaving for an equivalent gain in stiffness.

In addition, by interposing a mat of thermoplastic material filled with carbon nanotubes between the interface of the fibrous texture layer and the multiaxial fibrous sheet, the bond at this interface is reinforced without the need for sewing or needling, for example. Once the casing of composite material has been manufactured, carbon nanotubes are present at the interfaces between the winding turns of the different layers making up the composite material of the casing, which reinforced the strength of the preform to delamination in these areas.

In this application, weaving, fabric or woven means an entanglement of yarns, in particular weft and warp, in a particular pattern. The weaving can be carried out in a plane and therefore in two dimensions, or can form a volume and therefore be defined in three dimensions.

A “three-dimensional weaving” or “3D weaving” is a weaving mode in which at least some of the warp yarns bind weft yarns over several weft layers. A reversal of roles between warp and weft yarns is possible in the present application.

A multiaxial sheet (NCF for Non Crimp Fabric) is a textile fabric that generally has several layers of unidirectional non-woven fibres oriented in different directions and bonded by a fine knitting yarn.

The carbon nanotube mat is a layer of a fugitive material, i.e. one that can be removed during manufacture, filled with the carbon nanotubes. In this example, the fugitive material is a mat of thermoplastic material.

A “winding” or “winding turn” is defined as a complete turn (in particular 360°) of each of the layers making up the fibrous preform about the longitudinal axis A. The axis A corresponds to the longitudinal axis around which the casing of the turbine engine to be produced extends.

The preform according to the invention may comprise one or more of the following characteristics, taken alone or in combination with each other:
the preform comprises at least a first and a second layer of fibrous texture, between which the mats and the fibrous sheet are arranged;
1 the preform comprises a first and a second mat, wherein the first mat is interposed between the fibrous sheet and the first layer of fibrous texture, and the second mat is interposed between said fibrous sheet and the second layer of fibrous texture.
the thermoplastic material of the mat has a melting temperature of between 85° C. and 150° C., preferably between 100 and 110° C.;
the thermoplastic material of the mat comprises non-woven thermoplastic fibres;
1 the non-woven thermoplastic fibre mat has a weight per unit area of between 15 g/m² and 100 g/m², for example 19 g/m²;
the carbon nanotubes are multi-walled carbon nanotubes, preferably with a diameter of 10 nm and a length of 2 μm.
the carbon nanotubes are single-walled carbon nanotubes, preferably with a diameter of 2 nm and a length of 5 μm.

The invention also relates to a method for manufacturing an annular casing of composite material for a turbine engine, in particular for an aircraft, comprising the steps of:
(a) producing at least one layer of a fibrous texture by three-dimensional weaving or multi-layer,
(b) providing at least one mat comprising a thermoplastic material filled with carbon nanotubes,
(c) providing at least one multiaxial fibrous sheet,
(d) simultaneously winding said at least one layer of fibrous texture, said at least one mat and said at least one fibrous sheet about a longitudinal axis A on a mandrel with a profile corresponding to that of the casing to be manufactured, the mat being interposed between the fibrous sheet and said at least one layer of fibrous texture so as to form a fibrous preform according to one of the particularities of the invention,
(e) densifying the fibrous preform with a matrix to form the composite material of the part.

The manufacturing method according to the invention has the advantage of winding, simultaneously and over several turns, each layer of fibrous texture, the fibrous sheet and each mat comprising a thermoplastic material filled with carbon nanotubes. This allows to produce a casing with a fibrous preform comprising carbon nanotubes arranged at each of the bonding interfaces between the fibrous sheet and each layer of fibrous texture. This increases the resistance of the fibrous preform to the delamination.

Advantageously, the step (e) of densifying the fibrous preform comprises impregnating the preform with a resin and converting the resin into a matrix by thermal treatment.

Each mat can have a melting temperature below the temperature of consolidation of the resin.

Preferably, the step (b) comprises a sub-step (b1) of mixing a thermoplastic polymer and carbon nanotube powder.

The thermoplastic polymer can have a melting temperature of between 55° C. and 150° C., preferably between 100° C. and 110° C.

The thermoplastic polymer can be a copolymer based on polycaprolactam and polyhexamethylene adipamide.

The mixture of thermoplastic polymer and carbon nanotube powder in step (b1) can be filled with between 1% and 10%, preferably between 3% and 4%, by weight of carbon nanotube powder.

Step (b) may further comprise:
a sub-step (b2) of extruding said mixture resulting from said mixing sub-step (b1) through a die dimensioned to obtain nanotube-filled thermoplastic polymer filaments having a diameter of between 30 and 70 micrometres;
a sub-step (b3) of melting and blowing said nanotube-filled thermoplastic polymer filaments.

Advantageously, the mat or mats each have a first width and the fibrous sheet has a second width which are equal to a third width of the fibrous texture.

Alternatively, the fibrous texture has a third width greater than a first width of the mat or mats and a second width of the fibrous sheet.

The present invention also relates to an annular casing made of composite material for a turbine engine, in particular for an aircraft, implemented by the manufacturing method according to one of the particularities of the invention.

The casing of the invention has both a lighter overall mass and an enhanced mechanical resistance (such as, for example, to delamination-type damage), thanks to the presence of carbon nanotubes and the multiaxial fibrous sheet at the interface between the fibrous sheet and each layer of fibrous texture. As a result, the casing is more resistant to shocks and impacts, while at the same time optimising its rigidity in relation to its mass.

The casing may be a fan casing or an intermediate casing for the turbine engine.

The present invention also relates to a turbine engine, in particular for an aircraft, comprising an annular casing made of composite material according to the invention.

The turbine engine may be a turbojet engine or an aircraft turboprop.

### BRIEF DESCRIPTION OF THE FIGURES

The invention will be better understood and other details, characteristics and advantages of the present invention will become clearer from the following description made by way of non-limiting example and with reference to the attached drawings, in which:

FIG. 1 is a schematic perspective view and partial cross-section of a turbine engine equipped with an annular fan casing made of composite material and/or an annular intermediate casing made of composite material according to one embodiment of the invention;

FIG. 2 is a schematic sectional view in plane II-II of the fan casing made of composite material shown in FIG. 1;

FIG. 3 is an enlarged view of a fibrous preform of the casing in FIG. 2;

FIG. 4 is a schematic perspective view of a loom showing the weaving of a fibrous texture used in the fibrous preform of FIG. 2;

FIG. 5 is a schematic view of the steps involved in making a mat comprising a carbon nanotube-filled thermoplastic material used in the fibrous preform of FIG. 2;

FIG. 6 is a schematic perspective view showing the shaping of the fibrous preform to produce the casing of FIGS. 1 and 2;

FIG. 7 is a schematic view illustrating a step in winding the fibrous preform of FIG. 6 for the manufacture of the casing of FIGS. 1 and 2.

### DETAILED DESCRIPTION OF THE INVENTION

The invention applies generally to any part of revolution made of composite material, the fibrous preform of which forms a fibrous reinforcement and comprises at least one three-dimensional or multilayer woven strip wound over several turns.

The invention will be described below in the context of its application to an annular casing made of composite material for a turbine engine, in particular for an aircraft, such as a fan casing and/or an intermediate casing for the engine of the turbine engine.

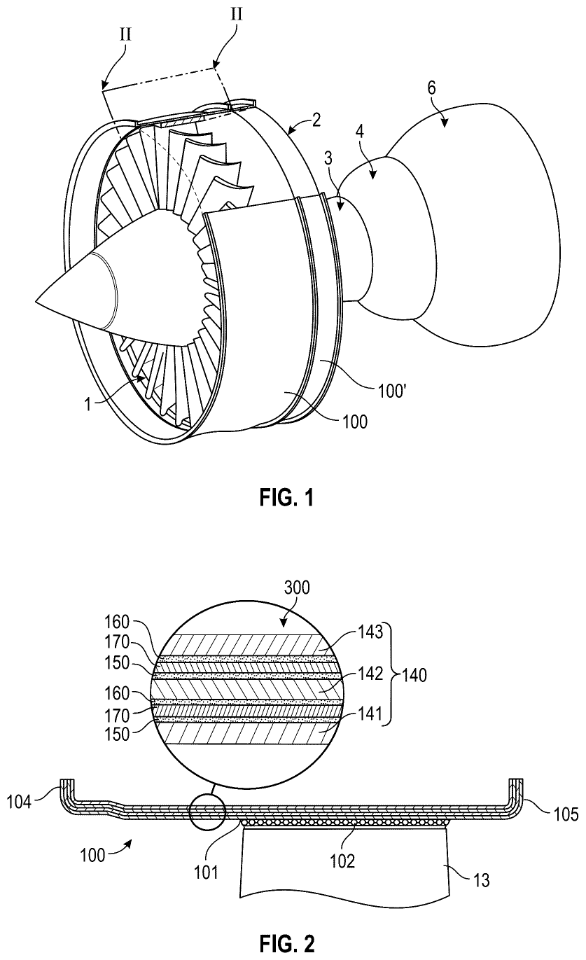

Such a turbine engine, illustrated schematically and in a non-limiting manner in FIG. 1, comprises, from upstream to downstream in the direction of gas flow, a fan 1 arranged at the inlet of the engine, a compressor 2, a combustion chamber 3, a high-pressure turbine 4 and a low-pressure turbine 5.

The engine is housed inside a casing comprising several portions corresponding to different elements of the engine. The fan 1 is surrounded by an external casing 100, referred to as the fan casing, and the compressor 2 is surrounded by the intermediate casing 200. In FIG. 1, the fan casing 100 comprises a downstream end stretch (with respect to the direction of gas flow in the turbine engine) connected to an external shell of an intermediate casing 100′. More specifically, the downstream end stretch of the fan casing 100 is flanged to the external shell of the intermediate casing 100′. The intermediate casing 100′ can incorporate a plurality of fan outlet guide vanes, referred to as OGV vanes, which are not illustrated in the figures.

The fan casing 100 and/or the intermediate casing 100′ can be made of composite material using the method described below. FIG. 2 illustrates a profile of a fan casing 100 made of composite material, as obtained by a method according to the invention. The casing comprises an internal surface 101 which defines the air inlet duct. This internal surface 101 may be equipped with an abradable coating layer 102 in line with the trajectory of the summits of the vanes 13 of the fan (one vane 13 being partially illustrated in FIG. 2). The abradable coating 102 can therefore be arranged over only one portion of the length (in the axial direction) of the casing. An acoustic treatment coating (not shown) can also be applied to the internal surface 101, particularly upstream of the abradable coating 102.

The casing 100 can be equipped with external flanges 104, 105 at its upstream and downstream ends to allow it to be mounted and connected to other elements. In particular, the external flange 105 is mounted with the external shell of the intermediate casing 100′.

The casing 100 is made of a fibre-reinforced composite material densified by a matrix forming a fibrous preform 300.

The preform 300 is formed by winding around a longitudinal axis A on a mandrel 200 of a fibrous texture 140 produced by 3D weaving or multilayer with a constant or changing thickness, the mandrel 200 having a profile corresponding to that of the casing 100 to be produced. Advantageously, the preform 300 has a complete profile of the casing 100 forming a single piece with reinforcing portions corresponding to the flanges 104, 105.

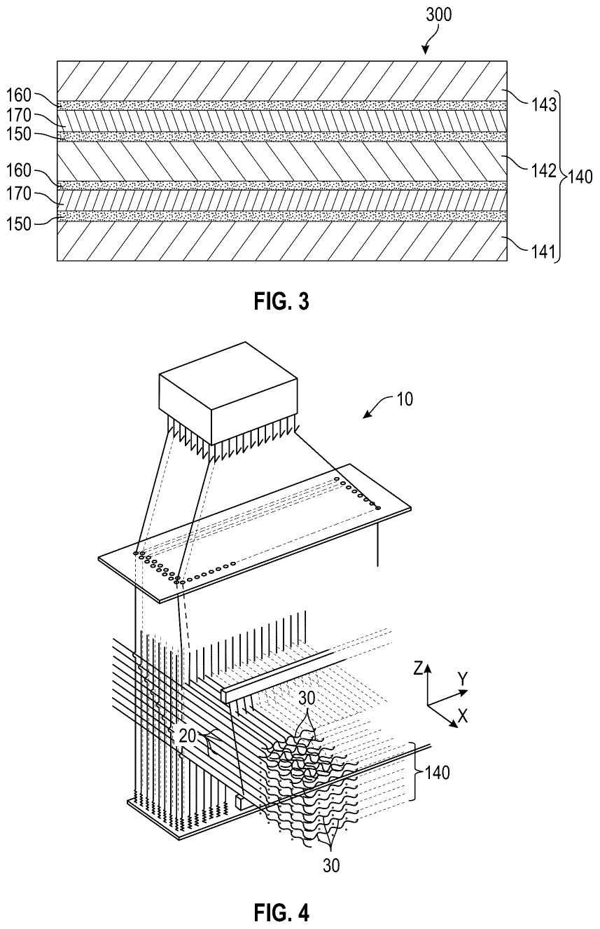

With reference to FIGS. 2 and 3, the preform 300 according to the invention comprises:
at least one layer 141, 142, 143 of the fibrous texture 140 having a 3D weaving or multilayer and extending around the axis A (in FIG. 2, layers 141 to 143 are densified by a matrix);
at least one mat 150, 160 comprising a thermoplastic material filled with carbon nanotubes, and extending around the axis A; and
at least one multiaxial fibrous sheet 170 extending around the axis A. The preform 300 illustrated in FIGS. 2 and 3 comprises in particular two mats 150, 160 each comprising a thermoplastic material filled with carbon nanotubes and extending around the axis A.

One of the particularities of the invention is that the mat or mats 150 and 160 are interposed between the fibrous sheet 170 and each layer 141, 142, 143 of fibrous texture 140.

In this example, the fibrous sheet 170 is sandwiched between each of the layers 141, 142, 143 of fibrous texture. Mats of carbon nanotubes 150, 160 are present between the fibrous sheet 170 and each of the layers 141, 142, 143. The bond at the interface between the fibrous sheet and the fibrous texture layer is thus reinforced by the presence of carbon nanotubes.

The number of layers of fibrous texture 140 can vary depending on the desired thickness of the fibrous preform and the thickness of the fibrous texture used. This number can be at least 2. Advantageously, the fibrous preform 300 of the casing 100 comprises at least a first layer 141 and a second layer 142 of fibrous texture. The fibrous sheet 170 and the mat or mats 150, 160 are arranged between the first 141 and second 142 layers. This or those mats 150, 160 of carbon nanotube may comprise a first mat 150 and a second mat 160. In this case, the first mat 150 is located between the fibrous sheet 170 and the first layer 141 and the second mat 160 is located between this fibrous sheet 170 and the second layer 142.

FIG. 3 provides a non-limiting illustration of the preform 300, which comprises a first layer 141, a second layer 142 and a third layer 143 with a fibrous texture 140. This preform 300 also comprises several layers of fibrous sheet 170 and several layers of first and second mats 150, 160. In this preform 300, each fibrous sheet 170 is interposed between the first and second mats 150, 160 to form an assembly of superimposed layers 150, 170, 160. This assembly 150, 170, 160 is interposed between the first and second layers 141, 142 and between the second and third layers 142, 143 of fibrous texture. This configuration allows to reinforce all the bonds at the interface between each fibrous sheet and each of the fibrous texture layers.

In the present application, it should be noted that the layers 141, 142, 143 advantageously form a single continuous strip of the fibrous texture 140. The fibrous sheet 170 is also in the form of a continuous strip. The first mat 150 and second mat 160 are also each in the form of a continuous strip. Preferably, the first mat 150 is a separate strip from the second mat 160.

In addition, the strip length of the fibrous texture 140 is longer than the strips of the fibrous sheet 170 and of the mats 150, 160. In the example, the fibrous texture 140 comprises an additional layer with respect to the fibrous sheet 170, the first mat 150 and the second mat 160. The fibrous preform 300 comprises a lower end formed by the first layer 141 and an upper end formed by the third layer 143. The lower and upper ends extend radially (or perpendicularly) to the axis A.

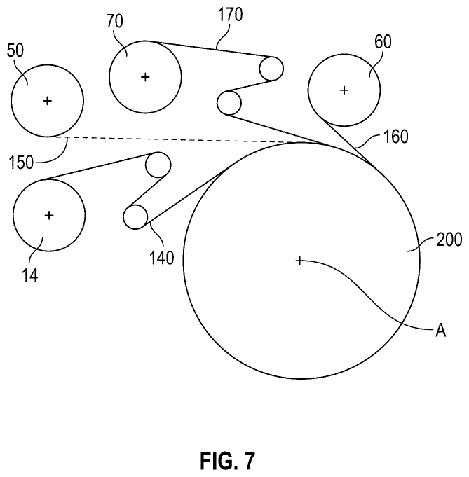

Thus, as described below with reference to FIGS. 6 and 7, the fibrous texture 140 in the form of a strip is configured to be wound over several turns around the mandrel 200 so as to superimpose the layers 141, 142, 143 on each other and form the preform 300. The fibrous sheet 170 in strip form is configured to wind around the mandrel 200 so as to interpose it between the layers 141, 142, 143 of the fibrous texture.

Each mat 150, 160 in strip form is configured to wind around the mandrel 200 so as to interpose each mat 150, 160 between the fibrous sheet 170 and each layer 141, 142 143 of the fibrous texture.

In this description, the annular casing of composite material made from the fibrous preform 300 of the invention is described with reference to the fan casing 100 of the turbine engine. Of course, the annular casing made of composite material can be the intermediate casing 100′.

The present application now describes a manufacturing method for the fan casing 100 and/or the intermediate casing 100′.

In accordance with the invention, the method comprises the following steps:
(a) producing by 3D weaving or multilayer at least one layer 141, 142, 143 of a fibrous texture 140, for example in the form of a strip,
(b) providing or producing at least one mat 150, 160 comprising a thermoplastic material filled with carbon nanotubes,
(c) providing at least one multiaxial fibrous sheet 170,
(d) simultaneously winding each layer 141, 142, 143 of fibrous texture, each mat 150, 160 and the fibrous sheet 170 about a longitudinal axis A on a mandrel 200 having a profile corresponding to that of the casing 100 to be manufactured, each mat 150, 160 being interposed between the fibrous sheet 170 and each layer 141, 142, 143 of the fibrous texture 140 so as to form a fibrous preform 300 of the invention, and
(e) densifying the fibrous preform 300 by a matrix to form the composite material of the part 100.

As shown in FIG. 4, the fibrous texture 140 of step (a) is produced by weaving using a jacquard-type loom 10 on which a bundle of warp yarns or strands 20 has been arranged in a plurality of layers, the warp yarns being bound by weft yarns or strands 30. The fibrous texture 140 thus has the shape of a strip which extends lengthwise in a direction X corresponding to the direction in which the warp yarns or strands 20 run and widthwise or transversely in a direction Y corresponding to the direction of the weft yarns or strands 30.

In this example, the fibrous texture 140 is produced by 3D weaving, such as interlock pattern weaving. By “interlock” weaving we mean a weaving pattern in which each layer of warp yarns binds together several layers of weft yarns with all the yarns of the same warp column having the same movement in the plane of the pattern.

The fibrous texture 140 can be woven from yarns of carbon fibre, ceramic such as silicon carbide, glass or aramid.

In one example of embodiment, the textile layers having a 3D weaving may comprise a first assembly of yarns or strands extending in a first woven direction with a second assembly of yarns or strands extending in a second direction perpendicular to the first.

The multiaxial fibrous sheet 170 may comprise at least a first layer of unidirectional fibres oriented at an orientation angle of, for example, +45° to the first direction of the fibrous texture 140, and a second layer of unidirectional fibres oriented at −45° to the first direction of the fibrous texture 140. These orientation angles can vary depending on the stiffness properties of the densified fibrous preform to be improved (for example, these orientation angles can be +30° and −30°).

The multiaxial fibrous sheet 170 can be made in particular from carbon fibre yarns, ceramic such as silicon carbide, glass or aramid.

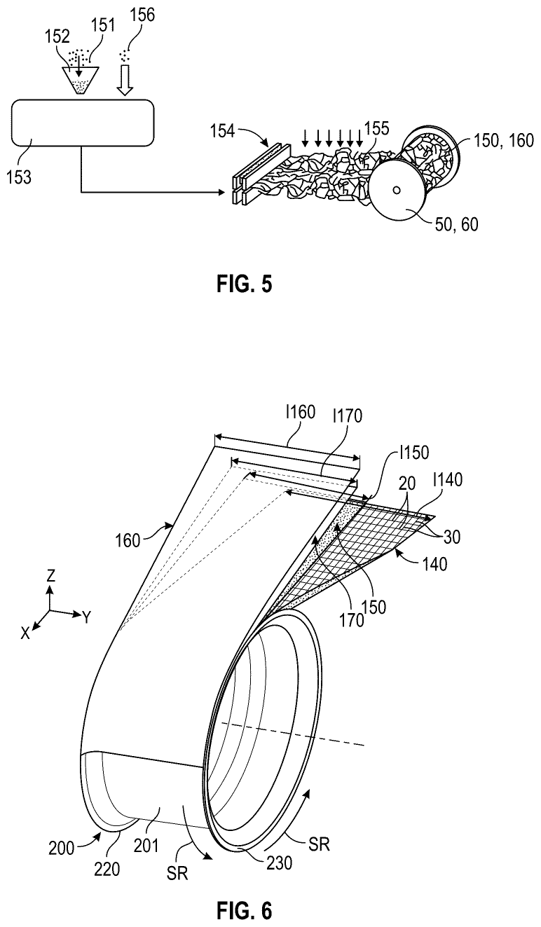

FIG. 5 illustrates step (b) of making each mat 150, 160 comprising a thermoplastic material filled with carbon nanotubes, such as carbon nanotubes incorporated into the entanglement of the thermoplastic fibres. The carbon nanotubes are used as reinforcement to improve the delamination resistance of the various structural layers of the composite part.

Advantageously, the thermoplastic fibres are non-woven. The thermoplastic fibres are held together by a thermal melt-blowing method, allowing to eliminate the need for a chemical binder. For example, the non-woven thermoplastic fibre mat has a basis weight of between 15 g/m² and 100 g/m², and preferably a basis weight of around 19 g/m².

With reference to FIG. 5, thermoplastic polymer granules or powder 151 are introduced via a feed hopper 152 into an extruder 153 having an “endless screw” (i.e. a threaded rod associated with a pinion) to produce a mixture. The extruder 153 comprises different heating areas to reduce the viscosity of the mixture along the endless screw. This mixture is then filled with powder of nanotube 156. The mixture is advantageously filled with between 1% and 10% powder of carbon nanotube 156, so as to obtain a mixture with a viscosity suitable for passing the heated mixture through a die 154. Preferably, the thermoplastic polymer blend is filled with between 3% and 4%, preferably about 3.5%, by weight of carbon nanotube powder 156. The endless screw of the extruder 153 continuously kneads, compresses, shears, heats and transports the filled mixture towards the die 154. The nanotube-filled mixture then passes through the die 154, which has a grid-like shape with relatively fine openings, so as to form thermoplastic polymer filaments 155 filled with nanotubes of a few tenths of a millimeter in diameter, for example between 30 and 70 μm. The various nanotube-filled thermoplastic filaments are then entangled and bonded together by a melting and blowing operation. Finally, the entangled and thermally bonded filaments 155 are wound around a rotating mandrel 70 so as to form a mat 150, 160 of non-woven thermoplastic fibres filled with nanotubes 156.

The thermoplastic polymer 151 used to make the mat 150, 160 of non-woven thermoplastic fibres filled with nanotubes 156 is a polymer with a low melting point ranging from 85° C. to 150° C. This temperature of the melting point of the thermoplastic polymer is chosen as a function of the nature of the matrix in the densification step (e), used to make the casing 100. By way of example, the thermoplastic polymer can be a co-polyamide PA6/PA66, based on polycaprolactam (polyamide 6 (PA 6)) and polyhexamethylene adipamide (polyamide 66 (PA 66)), with a melting point of around 106° C.

The carbon nanotubes 156 can be composed of one or more walled of atoms wound around themselves to form a tube. The nanotubes can be single-walled nanotubes (SWNT) or multi-walled nanotubes (MWNT).

When the nanotubes used are SWNT nanotubes, they have, for example, a diameter of around 2 nm and a length of around 5 μm.

When the nanotubes used are MWNT nanotubes, they have, for example, a diameter of around 10 nm and a length of around 2 μm.

For example, the nanotubes used are carbon nanotubes. However, other known types of nanotubes can be used instead of the carbon nanotubes mentioned in this invention.

As shown in FIG. 6, the fibrous preform 300 is formed by winding the fibrous texture 140 produced by 3D weaving onto a mandrel 200 driven in rotation in a direction SR, the mandrel having a profile corresponding to that of the casing to be produced.

In accordance with step (d) of the method of the invention, each mat 150, 160 of carbon nanotubes and the fibrous sheet 170 are wound with each layer 141, 142, 143 of fibrous texture, simultaneously and over several turns around the mandrel 200.

In FIG. 6, the first mat 150 is positioned below the fibrous sheet 170 and above the first layer 141 of fibrous texture. The second mat 160 is positioned above the fibrous sheet 170. This first layer 141, the first mat 150, the fibrous sheet 170 and the second mat 160 form a first assembly of superimposed layers 141, 150, 170, 160. This assembly 141, 150, 170, 160 is wound onto the mandrel 200 in a first complete 360° turn. This allows the first mat 150 to be interposed between the fibrous sheet 170 and the first layer 141 and the second mat 160 to be placed on the fibrous sheet 170. The second layer 142 is then wound onto the second mat 160 of the first assembly of layers 141, 150, 170, 160 of the first winding turn (not shown in FIG. 6). This second layer 142 is wound simultaneously with the first mat 150, the fibrous sheet 170 and the second mat 160, so as to form a second assembly of superimposed layers 142, 150, 170, 160 and make a second complete 360° turn around the mandrel 200.

In FIG. 6, each mat 150, 160 has a first width 1150, 1160 and the fibrous sheet 170 has a second width 1170 which are equal to a third width 1140 of the fibrous texture 140.

According to a variant, the first width 1150, 1160 of the mat or mats 150, 160 may be less than the third width 1140 of the fibrous texture 140. The mat or mats 150, 160 can be placed between the adjacent winding turns of the fibrous sheet and the fibrous texture at a position determined according to the reinforcement requirements at the interface between the turns.

In a quasi-similar way, the third width 1140 of the fibrous texture can be greater than the first widths 1150, 1160 of the mat or mats 150, 160 and of the second width 1170 of the fibrous sheet, so that the ends of the fibrous texture 140 roll up and form the external flanges 104, 105 of the casing 100. In this configuration, the external flanges 104, 105 do not comprise a multiaxial fibrous sheet 170.

Furthermore, with reference to FIGS. 6 and 7, the fibrous texture 140 in strip form is longer than the strips of the fibrous sheet 170 and the mats 150, 160. In the example, the winding in step (d) begins with the first layer 141 and ends with the third layer 143 of the fibrous texture, so as to form a fibrous preform 300 in which the first layer 141 and the third layer 143 form, respectively, the lower and upper ends of the preform.

Advantageously, the fibrous preform 300 constitutes a complete tubular fibrous reinforcement of the casing 100 forming a single piece with an allowance segment corresponding to the retention area of the casing. To this end, the mandrel 200 has an external surface 201 whose profile corresponds to the internal surface of the casing to be produced. As it is wound onto the mandrel 200, the fibrous texture 140 follows the profile of the mandrel. The mandrel 200 also comprises two flanges 220 and 230 for forming portions of the fibrous preform corresponding to the flanges 104 and 105 of the casing 100.

When the fibrous preform 300 is formed by winding on the mandrel 200, the layers 141, 142, 143 of fibrous texture 140 are called up from a drum 14. The fibrous sheet 170, the first mat 150 and the second mat 160 are called from the drums 50, 60 and 70 respectively, on which they are stored, as shown in FIG. 7.

The densification of the fibrous preform 300 in step (e) of the method (not illustrated in the figures) consists in filling the void in the preform, in all or part of its volume, with the material making up the matrix.

The matrix can be obtained using the liquid method.

The liquid method involves impregnating the preform with a liquid composition containing an organic precursor of the material of the matrix. The organic precursor is usually in the form of a polymer, such as a resin, optionally diluted in a solvent. The fibrous preform is placed in a sealable mould with a casing in the shape of the final moulded part. For example, the fibrous preform is placed between a plurality of sectors forming a counter-mould (not shown in the figures) and the mandrel forming a support, these elements respectively having the external shape and the internal shape of the casing to be produced. The liquid matrix precursor, for example a resin, is then injected into the entire casing to impregnate the entire fibrous portion of the preform.

The transformation of the precursor into an organic matrix, i.e. its polymerisation, is carried out by thermal treatment, generally by heating the mould, after elimination of any solvent and cross-linking of the polymer, the preform always being held in the mould having a shape corresponding to that of the part to be produced. The organic matrix can be obtained from epoxy resins, such as high-performance epoxy resin.

According to one aspect of the invention, the fibrous preform can be densified using the well-known RTM (Resin Transfer Moulding) method. In accordance with the RTM method, the fibrous preform is placed in a mould having the shape of the casing to be produced. A thermosetting resin is injected into the internal space between the mandrel and the counter-moulds. A pressure gradient is generally established in this internal space between the resin injection point and the resin evacuation orifices in order to control and optimise the impregnation of the preform by the resin.

The resin used can be, for example, an epoxy resin. The resins suitable for RTM methods are well known. They preferably have a low viscosity to facilitate their injection into the fibres. The choice of the temperature class and/or the chemical nature of the resin is determined by the thermomechanical stresses to which the part must be subjected. Once the resin has been injected throughout the reinforcement, it is polymerised by thermal treatment in accordance with the RTM method.

When the temperature is raised for the thermal treatment to transform the resin into a matrix, the thermoplastic material of each mat 150, 160 melts. The carbon nanotubes 156 then come into contact with the resin and form a reinforcing bond at the interface between the adjacent turns of the fibrous texture and of the multiaxial sheet.

Once the resin has been injected and transformed into the matrix, the shaped casing 100 is demolded. The casing 100 can be trimmed to remove excess resin and the chamfers machined to produce the casing 100 shown in FIGS. 1 and 2.

1. A fibrous preform for manufacturing an annular casing of composite material for a turbine engine the preform comprising:
at least one layer of a fibrous texture having a three-dimensional weaving or multilayer, and extending around a longitudinal axis (A);
at least one mat comprising a thermoplastic material filled with carbon nanotubes and extending around the axis (A); and
at least one multiaxial fibrous sheet extending around the axis (A), characterised in that wherein the mat is interposed between the fibrous sheet and said at least one layer of fibrous texture.

2. The preform according to claim 1, wherein the at least one layer of a fibrous texture includes first and second layers of fibrous texture between which are disposed the at least one mat and the fibrous sheet.

3. The preform according to claim 2, wherein the at least on mat includes first and second mats, the first mat being interposed between the fibrous sheet and the first layer of the fibrous texture, the second mat being interposed between said fibrous sheet and the second layer of the fibrous texture.

4. The preform according to claim 1, wherein the thermoplastic material of the at least one mat has a melting temperature of between 85° C. and 150° C.

5. The preform according to claim 1, wherein the carbon nanotubes are multi-walled carbon nanotubes.

6. The preform according to claim 1, wherein the carbon nanotubes are single-walled carbon.

7. The preform according to claim 1, wherein the thermoplastic material of the at least one mat comprises non-woven thermoplastic fibers.

8. The preform according to claim 7, wherein the non-woven thermoplastic fiber mat (150, 160) has a weight per unit area of between 15 g/m² and 100 g/m².

9. A method for manufacturing an annular casing of composite material for a turbine engine, the method comprising the steps of:
(a) producing at least one layer of a fibrous texture by three-dimensional weaving or multi-layer,
(b) providing at least one mat comprising a thermoplastic material filled with carbon nanotubes,
(c) providing at least one multiaxial fibrous sheet,
(d) simultaneously winding said at least one layer of fibrous texture, said at least one mat, and said at least one fibrous sheet about a longitudinal axis (A) on a mandrel with a profile corresponding to that of the casing to be manufactured, said at least one mat being interposed between the fibrous sheet and said at least one layer of fibrous texture so as to form the fibrous preform according to claim 1,
(e) densifying the fibrous preform with a matrix to form the composite material of the part.

10. The method according to claim 9, wherein that step (e) of densifying the fibrous preform comprises impregnating the preform with a resin and converting the resin into a matrix by thermal treatment, and in which the at least one mat has a melting temperature below a treatment temperature of the resin.

11. The method according to claim 9, wherein step (b) comprises a sub-step (b1) of mixing a thermoplastic polymer and powder of carbon nanotube, in which the thermoplastic polymer has a melting temperature of between 85° C. and 150° C.

12. The method according to claim 11, wherein the mixture of thermoplastic polymer and powder of carbon nanotube in step (b1) can be filled with between 1% and 10% by mass of carbon nanotube powder.

13. The method according to wherein each of the at least one mat has a first width and the fibrous sheet has a second width which are equal to a third width of the fibrous texture.

14. The method according to claim 9, wherein the fibrous texture has a third width greater than a first width of the at least one mat and a second width of the fibrous sheet.

15. The preform according to claim 4, wherein the thermoplastic material of the at least one mat has a melting temperature of between 100 and 110° C.

16. The preform according to claim 5, wherein the carbon nanotubes have a diameter of 10 nm and a length of 2 μm.

17. The preform according to claim 6, wherein the carbon nanotubes have a diameter of 2 nm and a length of 5 μm.

18. The method according to claim 11, wherein the thermoplastic polymer has a melting temperature of between 100 and 110° C.

19. The method according to claim 12, wherein the mixture of thermoplastic polymer and powder of carbon nanotube in step (b1) can be filled with between 3% and 4%, by mass of carbon nanotube powder.
